(19) United States
(12) Patent Application Publication
(10) Pub. No.: US 2026/0199888 A1
(43) Pub. Date: Jul. 16, 2026

(54) CARBON NANOTUBE-PORPHYRIN PHOTOCATALYSTS

(71) Applicants: COMMISSARIAT A L'ENERGIE ATOMIQUE ET AUX ENERGIES ALTERNATIVES, PARIS (FR); CENTRE NATIONAL DE LA RECHERCHE SCIENTIFIQUE (CNRS), PARIS (FR)

(72) Inventors: Edmond GRAVEL, GIF-SUR-YVETTE (FR); Joseph FARAH, PARIS (FR); Joel Armel TCHUITENG KOUATCHOU, GIF-SUR-YVETTE (FR); Florent MALLOGGI, GIF-SUR-YVETTE (FR); Eric DORIS, GIF-SUR-YVETTE (FR)

(21) Appl. No.: 19/135,190

(22) PCT Filed: Dec. 8, 2023
(86) PCT No.: PCT/EP2023/084841

§ 371 Date: Jun. 3, 2025

(30) Foreign Application Priority Data
Dec. 9, 2022 (EP) 22306831.3

(51) Int. Cl. B01J 31/02; B01J 21/18; B01J 31/06; B01J 35/39; B01J 37/02

(52) U.S. Cl. CPC B01J 31/0244; B01J 21/185; B01J 31/0271; B01J 31/063; B01J 35/39; B01J 37/0219; B01J 37/0228; B01J 37/0244; B01J 2231/70

(57) ABSTRACT

The present invention relates to an assembly comprising a carbon nanotube coated successively with: a primary coating resulting from the polymerisation of an amphiphilic diynic compound bearing an anionic or cationic group; optionally an intermediate coating of a cationic or anionic polymer; and a final coating of a porphyrin derivative which is either an anionic porphyrin or a cationic porphyrin, the coatings being linked to each other by electrostatic interactions. The present invention relates also to a method to prepare such an assembly and to its use as a photocatalyst, especially in a water medium, in particular in oxidation reactions, and for the production of singlet oxygen which is especially useful for disinfection or photodynamic therapy (PDT).

### TECHNICAL FIELD

The present invention relates to an assembly comprising a carbon nanotube coated successively with:
a primary coating resulting from the polymerisation of an amphiphilic diynic compound bearing an anionic or cationic group;
optionally an intermediate coating of a cationic or anionic polymer; and
a final coating of a porphyrin derivative which is either an anionic porphyrin or a cationic porphyrin,
   the coatings being linked to each other by electrostatic interactions.

The present invention relates also to a method to prepare such an assembly and to its use as a photocatalyst, especially in a water medium, in particular in oxidation reactions, and for the production of singlet oxygen which is especially useful for disinfection or photodynamic therapy (PDT).

### BACKGROUND

Oxidation reactions of organic substrates are key transformations found in a number of industrial processes such as the synthesis of active pharmaceutical ingredients.

These reactions can be triggered by stoichiometric oxidants that however generate (toxic) by-products and often operate in organic solvents. In some cases, more environmentally friendly oxidation reactions can be implemented based on photocatalytic approaches and involving a suitable photosensitizer (e.g. porphyrins) in combination with oxygen from the air. The latter option offers the advantage of producing by-product-free reaction mixtures and employs sub-stoichiometric amounts of the catalyst needed to bring oxygen to its oxidizing state.

Porphyrins have been widely used as photosensitizers in oxidation reactions because they efficiently catalyse, under light irradiation, the production of reactive oxygen species, in particular singlet oxygen, which has a strong oxidizing power on organic substrates. Porphyrins can thus be used for disinfection, photodynamic therapy, degradation of pollutants, photocatalysis, etc. (Buglak et al. 2020; Costa e Silva et al. 2020).

Porphyrins are generally used as homogeneous photocatalysts, which implies tedious and expensive procedures to separate the products from the catalyst at the end of the reaction. These procedures can also lead to degradation and waste of valuable catalyst material. Furthermore, oxidation reactions involving porphyrins as photocatalysts often operate in organic solvents (which is not appropriate from a sustainable chemistry perspective), as reagents are not soluble in an aqueous medium.

Assemblies of single-walled carbon nanotubes (SWCNTs) with a cationic derivative of pyrene and an anionic derivative of a porphyrin derivative are known but no application as a photocatalyst is described (Ehli et al. 2006).

Porphyrins were also covalently linked to single-walled carbon nanotubes by a click reaction. The obtained hybrids were investigated for their nonlinear optical performance but no application as a photocatalyst was described (Zhang et al. 2017).

Multiwall carbon nanotubes were also non-covalently functionalized by a uniform layer of a porphyrin-Sn network that was assembled by cross-linking tetra(4-carboxyphenyl) porphyrin with SnCl₂. The obtained hybrid structure showed high adsorption capacity for proteins such as bovine serum albumin but no activity as a photocatalyst was reported (Wang et al. 2021).

Carboxylic functionalized multi-walled carbon nanotubes were decorated by different porphyrin moieties such as (5-(4-aminophenyl)-10,15,20-(triphenyl)porphyrin and 5-(4-carboxyphenyl)-10,15,20-(triphenyl)porphyrin) and photocatalytic performances investigated in the photodegradation of rhodamine (Spencer et al. 2022). This approach implies to chemically modify the carbon nanotubes so that they can be decorated with the porphyrin moieties.

Porphyrin derivatives in the form of micelles containing Ru(II)-porphyrin complexes are disclosed for the oxidation of terminal olefins in water (Lu et al. 2016). However, the synthesis of the catalyst is complex. and the oxidation reaction involves H₂O₂ and not a photoactivation of dioxygen.

There is therefore a need to develop new catalytic systems capable of promoting photo-oxidation reactions under sustainable conditions, with a focus on improved resource management, product selectivity, practicality, and overall safety. To fulfil the above requirements, a promising option is the immobilization of the homogeneous catalytic functions onto a solid support, through a process called heterogenization. The latter offers some advantages, including easier catalyst handling, separation, work-up, catalyst recovery and reusability, and more flexibility. The choice of a solid support capable of interacting in synergy with the catalyst could also contribute to the better overall efficacy of the process, and in particular enable photo-catalysed reactions in water by acting as a nanoreactor capable of encapsulating the reagents and favouring their aqueous dispersion.

### SUMMARY OF THE INVENTION

The inventors of the present invention have developed an assembly associating a photo-responsive porphyrin unit (active catalytic species) to a carbon nanotube-based platform (for recycling) which can be used as photocatalyst, and more particularly as a heterogenized photocatalyst that can be easily recovered at the end of the catalysed reaction.

The carbon nanotube-based platform is also electronically active (for stabilization of the excited states of the porphyrin) and could behave as a nanoreactor (to allow reactions in water). Assembly of the porphyrin on nanotubes creates, at the interface with the nanotube, a confined domain that promotes aqueous dispersion of the reagents and their concentration at the vicinity of the active sites of the catalyst.

The present invention relates to an assembly comprising a carbon nanotube coated successively with:
a primary coating resulting from the polymerisation of an amphiphilic diynic compound of following formula (I):

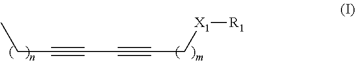

wherein:
   n is an integer from 6 to 20, especially from 8 to 15, in particular is 11,
   m is an integer from 4 to 20, especially from 5 to 15, in particular from 6 to 12, more particularly is 8 or 9,
   X₁ is a covalent bond or a spacer unit, and
   R₁ is an anionic group selected from COO⁻, SO₃⁻, OSO₃⁻, N((CH₂)_{q1}COO⁻)((CH₂)_{q2}COO⁻), N((CH₂)_{q1}SO₃⁻)((CH₂)_{q2}SO₃⁻), N((CH₂)_{q1}OSO₃⁻)((CH₂)_{q2}OSO₃⁻), CH((CH₂)_{q3-1}COO⁻)N((CH₂)_{q1}COO⁻)((CH₂)_{q2}COO⁻), CH((CH₂)_{q3-1}SO₃⁻)N((CH₂)_{q1}SO₃⁻)((CH₂)_{q2}SO₃) and CH((CH₂)_{q3-1}OSO₃⁻)N((CH₂)^{q1}OSO₃⁻)((CH₂)_{q2}OSO₃⁻) with q1, q2 and q3, identical or different, preferably identical, each representing 1, 2, 3, 4, 5 or 6, preferably 1; or a cationic group selected from N⁺Alk₁Alk₂Alk₃,

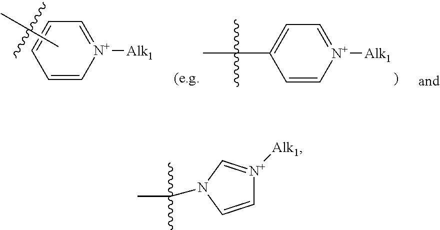

wherein Alk₁, Alk₂ and Alk₃ are independently a (C₁-C₆)alkyl (e.g. a methyl);
optionally an intermediate coating of a cationic polymer if R₁ is an anionic group or an anionic polymer if R₁ is a cationic group; and
a final coating of a porphyrin derivative which is either an anionic porphyrin or a cationic porphyrin,
wherein the anionic porphyrin is an anionic tetraphenylporphyrin of following formula (IIa) or an anionic protoporphyrin of following formula (IIb):

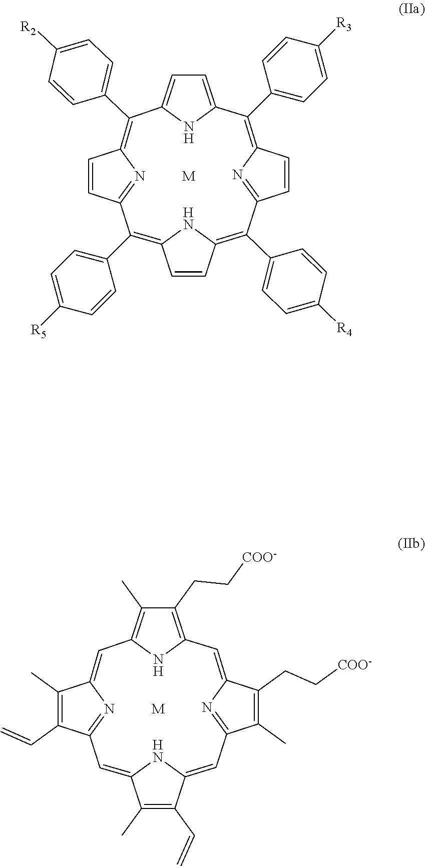

wherein:
   M is absent or is a metal selected from Zn, Mn, Fe, Cu, Co and Ni, and
   R₂, R₃, R₄, and R₅, identical or different, preferably identical, are selected from H, X₂COO⁻, X₂SO₃⁻, and X₂OSO₃⁻, wherein X₂ is a covalent bond or a spacer unit, in particular a covalent bond, and wherein at least one of R₂, R₃, R₄, and R₅ is not H,
wherein the cationic porphyrin is a cationic tetraphenylporphyrin of following formula (IIc) or a cationic porphyrin of following formula (IId):

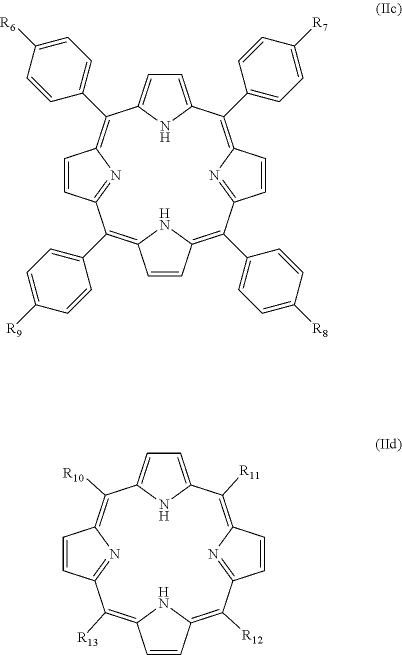

wherein:
   M is as defined above,
   R₆, R₇, R₈, and R₉, identical or different, preferably identical, are selected from H, X₃N⁺Alk₄Alk₅Alk₆,

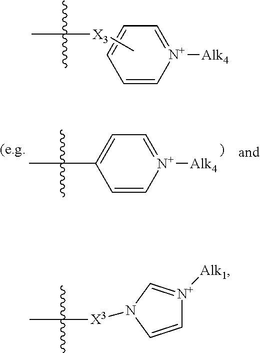

wherein X₃ is a covalent bond or a spacer unit, in particular a covalent bond, wherein Alk₄, Alk₅ and Alk₆ are independently a (C₁-C₆)alkyl (e.g. a methyl), and wherein at least one of R₆, R₇, R₈, and R₉ is not H, and
R₁₀, R₁₁, R₁₂, and R₁₃, identical or different, preferably identical, are selected from H, X₃N⁺Alk₄Alk₅Alk₆,

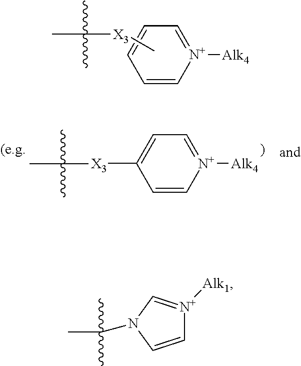

wherein X₃, Alk₄, Alk₅ and Alk₆ are as defined above, and wherein at least one of R₁₀, R₁₁, R₁₂, and R₁₃ is not H,
wherein the porphyrin derivative is:
   a cationic porphyrin when R₁ is an anionic group and there is no intermediate coating or when R₁ is a cationic group and there is an intermediate coating of an anionic polymer, and
   an anionic porphyrin when R₁ is a cationic group and there is no intermediate coating or when R₁ is an anionic group and there is an intermediate coating of a cationic polymer.

In the assembly according to the invention, the primary, intermediate (if present) and final coatings are linked to each other by electrostatic interactions between anionic and cationic groups. If the anionic and cationic groups are not involved in such electrostatic interactions, they are associated to a counter-ion. A counter-ion of an anionic group may be Na⁺, K⁺, or NH₄⁺, preferably Na⁺. A counter-ion of a cationic group may be Cl⁻, Br⁻ or I⁻, preferably Cl⁻.

Moreover, the peculiar structure of the compound of formula (I) creates a hydrophobic domain located at the interface of the lipophilic chains of the polymerised compounds of formula (I) and the surface of the carbon nanotube. This allows reactions in a water medium, even with reagents insoluble in water. Indeed, this domain can accommodate hydrophobic reagents in such a way that it could behave as a nanoreactor, favouring the aqueous dispersion of the reagents and their concentration at the vicinity of the active sites of the catalyst. At the same time, the hydrophobic domain will transiently isolate the reagents from water, thus minimizing interference of the aqueous medium on the outcome of the transformation.

The present invention also relates to a method to prepare an assembly according to the invention comprising the following successive steps:
1) coating the carbon nanotube with a salt of an amphiphilic diynic compound of formula (I), and then polymerising the amphiphilic diynic compound of formula (I) in order to obtain a carbon nanotube coated with the primary coating;
2) optionally coating the carbon nanotube coated with the primary coating obtained in step 1) with a salt of a cationic or anionic polymer in order to obtain a carbon nanotube coated with the primary coating and the intermediate coating; and
3) coating the carbon nanotube coated with the primary coating obtained in step 1) or the carbon nanotube coated with the primary coating and the intermediate coating obtained in step 2) with a salt of the porphyrin derivative in order to obtain an assembly according to the invention.

In this method, thanks to their amphiphilic nature, the amphiphilic diynic compounds of formula (I) will form hemi-micelles with nanoring-like structures around the carbon nanotube, the lipophilic diynic part of the compound of formula (I) being adsorbed on the hydrophobic carbon nanotube by van der Waals interactions, while the anionic or cationic head of the compound of formula (I) is present on the external surface of the coating and oriented toward the reaction medium. The polymerization of the diyne functions allows stabilizing this coating to form the primary coating. This polymerization takes place within individual half-cylinders and reinforces the cohesion of the assembly.

The intermediate coating (when present) and the final coating are then formed respectively in steps 2) and 3) thanks to electrostatic interactions.

The assembly according to the invention can be used as a photocatalyst, i.e. under light irradiation, especially in an oxidation reaction, in particular in the presence of dioxygen (e.g. air). This assembly can be used in water.

The assembly according to the invention can also be used for the production of singlet oxygen, in particular in the presence of dioxygen (e.g. air). In consequence, it can be used for disinfection and as a photosensitizer agent in photodynamic therapy.

### Definitions

A carbon nanotube, abbreviated CNT, is well-known in the art. It refers to an allotrope of carbon which is a tubular structure made of carbon with a diameter in the range of nanometer, typically in the range from 0.6 to 150 nm. It may be a single-walled carbon nanotube (SWCNT) which a cylinder made of carbon with a hexagonal lattice. It may be also a multi-walled carbon nanotube (MWCNT) which consists of several single-walled carbon nanotubes nested within each other. The diameter of the single-walled carbon nanotube is typically in the range from 0.6 to 4 nm. The diameter of the multi-walled carbon nanotube is typically in the range from 4 to 150 nm.

The term “(C₁-C₆)alkyl”, as used in the present invention, refers to a straight or branched saturated hydrocarbon chain containing from 1 to 6 carbon atoms including methyl, ethyl, n-propyl, iso-propyl, n-butyl, iso-butyl, sec-butyl, t-butyl, n-pentyl, or n-hexyl. It can be in particular methyl.

The term “(C₁-C₆)alkanediyl” as used in the present invention refers to a straight or branched, preferably straight, divalent saturated hydrocarbon chain containing from 1 to 6 carbon atoms including methanediyl, ethanediyl, propanediyl, butanediyl, pentanediyl, or hexanediyle. It can be a chain of formula —(CH₂)_{y}— with y=1, 2, 3, 4, 5 or 6.

### DETAILED DESCRIPTION

### Catalyst

The present invention relates to an assembly comprising a carbon nanotube coated successively with:
a primary coating resulting from the polymerisation of an amphiphilic diynic compound of formula (I) bearing a R₁ group which is anionic or cationic;
optionally an intermediate coating of a cationic polymer if R₁ is an anionic group, or an anionic polymer if R₁ is a cationic group; and
a final coating of a porphyrin derivative which is either an anionic porphyrin of formula (IIa) or (IIb) or a cationic porphyrin of formula (IIc) or (IId),
   wherein the porphyrin derivative is:
      a cationic porphyrin when R₁ is an anionic group and there is no intermediate coating or when R₁ is a cationic group and there is an intermediate coating of an anionic polymer, and
      an anionic porphyrin when R₁ is a cationic group and there is no intermediate coating or when R₁ is an anionic group and there is an intermediate coating of a cationic polymer.

According to a first embodiment, the assembly comprises a carbon nanotube coated successively with:
a primary coating resulting from the polymerisation of an amphiphilic diynic compound of formula (I) bearing a R₁ group which is anionic;
an intermediate coating of a cationic polymer; and
a final coating of a porphyrin derivative which is an anionic porphyrin of formula (IIa) or (IIb).

According to a second embodiment, the assembly comprises a carbon nanotube coated successively with:
a primary coating resulting from the polymerisation of an amphiphilic diynic compound of formula (I) bearing a R₁ group which is cationic;
an intermediate coating of an anionic polymer; and
a final coating of a porphyrin derivative which is a cationic porphyrin of formula (IIc) or (IId).

According to a third embodiment, the assembly comprises a carbon nanotube coated successively with:
a primary coating resulting from the polymerisation of an amphiphilic diynic compound of formula (I) bearing a R₁ group which is anionic; and
a final coating of a porphyrin derivative which is a cationic porphyrin of formula (IIc) or (IId).

According to a fourth embodiment, the assembly comprises a carbon nanotube coated successively with:
a primary coating resulting from the polymerisation of an amphiphilic diynic compound of formula (I) bearing a R₁ group which is cationic; and
a final coating of a porphyrin derivative which is an anionic porphyrin of formula (IIa) or (IIb).

In each of the above-mentioned embodiments, the nature of the carbon nanotube is not critical. The carbon nanotube may be either a multi-walled carbon nanotube or a single-walled carbon nanotube.

In each of the above-mentioned embodiments, the primary coating, the intermediate coating (when present) and the final coating may be as further defined below.

### Primary Coating

The primary coating results from the polymerisation of the diyne moiety of an amphiphilic diynic compound of formula (I). This polymerisation takes place once the carbon nanotube is coated with the amphiphilic diynic compound of formula (I).

In formula (I), X₁ is a covalent bond or a spacer unit. The spacer unit may have the formula -A₁-L₁- wherein:
A₁ is linked to the moiety comprising the diyne group and is selected from O, NR₁₄, CO, COO, CONR₁₄, OCO and NR₁₄CO⁻; in particular from O, NR₁₄, COO, and CONR₁₄; especially from O, NR₁₄, and CONR₁₄; with R₁₄ being H or a (C₁-C₆)alkyl, and
L₁ is linked to R₁ and is a covalent bond or a (C₁-C₆)alkanediyl (e.g. (CH₂)ₚ₁ with p1=1, 2, 3, 4, 5 or 6), L₁ being not a covalent bond when it is linked to a heteroatom (e.g. N or O) of R₁.

Thus, X₁ may be a covalent bond, O, NR₁₄, CONR₁₄, —O—(CH₂)ₚ₁—, —NR₁₄—(CH₂)ₚ₁—, or —CONR₁₄—(CH₂)ₚ₁—; in particular a covalent bond, CONR₁₄, —O—(CH₂)ₚ₁—, or —CONR₁₄—(CH₂)ₚ₁—, with p1 as defined above, wherein the first atom of these groups is linked to the moiety comprising the diyne group and the last atom is linked to R₁, wherein X₁ is not O, NR₁₄, or CONR₁₄ when it is linked to a heteroatom (e.g. N or O) of R₁.

In formula (I), R₁ is an anionic group selected from COO⁻, SO₃⁻, OSO₃⁻, N((CH₂)_{q1}COO⁻)((CH₂)_{q2}COO⁻), N((CH₂)_{q1}SO₃⁻)((CH₂)_{q2}SO₃⁻), N((CH₂)_{q1}OSO₃⁻)((CH₂)_{q2}OSO₃⁻), CH((CH₂)_{q3-1}COO⁻)N((CH₂)_{q1}COO⁻)((CH₂)_{q2}COO⁻), CH((CH₂)_{q3-1}SO₃⁻)N((CH₂)_{q1}SO₃⁻)((CH₂)_{q2}SO₃⁻) and CH((CH₂)_{q3-1}OSO₃⁻)N((CH₂)_{q1}OSO₃⁻)((CH₂)_{q2}OSO₃⁻) with q1, q2 and q3 as defined and preferably each being 1; or a cationic group selected from N⁺Alk₁Alk₂Alk₃,

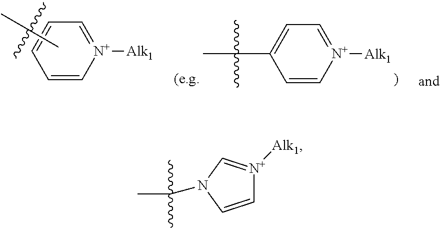

in which Alk₁, Alk₂ and Alk₃ are independently a (C₁-C₆)alkyl, preferably a methyl.

In particular, R₁ is an anionic group selected from COO⁻, OSO₃⁻, N((CH₂)_{q1}COO⁻)((CH₂)_{q2}COO⁻) (e.g. N(CH₂COO⁻)₂), and CH((CH₂)_{q3-1}COO⁻)N((CH₂)_{q1}COO⁻)((CH₂)_{q2}COO⁻) (e.g. CH(COO⁻)N(CH₂COO⁻)₂) with q1, q2 and q3 as defined and preferably each being 1; or a cationic group selected from N⁺Alk₁Alk₂Alk₃,

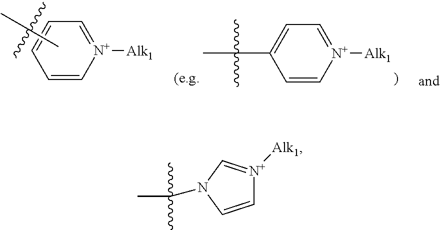

in which Alk₁, Alk₂ and Alk₃ are independently a (C₁-C₆)alkyl, preferably a methyl.

According to a particular embodiment, the amphiphilic diynic compound of formula (I) is anionic and is selected from:

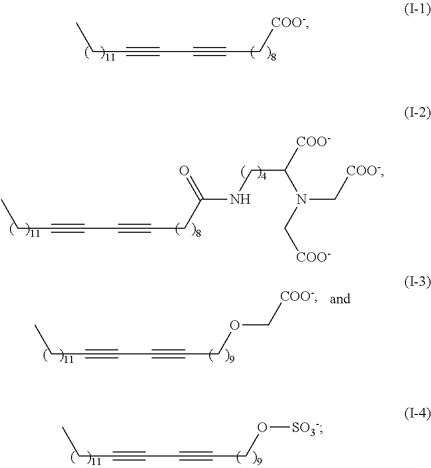

or is cationic and is selected from:

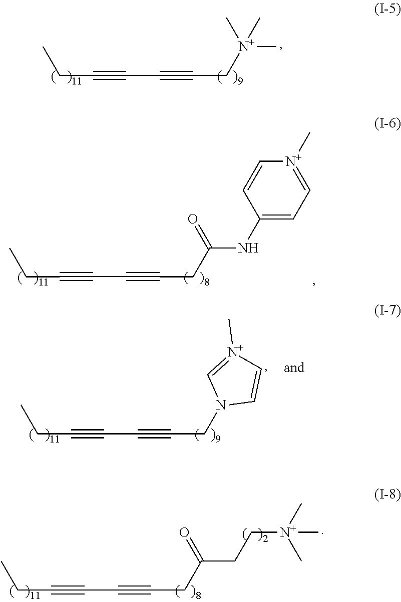

### Optional Intermediate Coating

The intermediate coating, when present, is made of a cationic polymer or an anionic polymer.

The cationic polymer may be a poly(diallyldi(C₁-C₆)alkylammonium) such as a poly(diallyldimethylammonium)

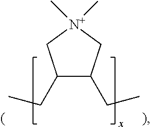

a poly(lysine) in which the NH₂ group of the side chain has been replaced by a tri(C₁-C₆)alkylammonium such as trimethylammonium

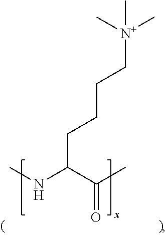

or a poly(allylamine) in which the NH₂ group of the side chain has been replaced by a tri(C₁-C₆)alkylammonium such as trimethylammonium

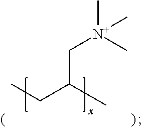

in particular a poly(diallyldi(C₁-C₆)alkylammonium) such as a poly(diallyldimethylammonium).

The anionic polymer may be an anionic form of a poly(glutamic acid) (

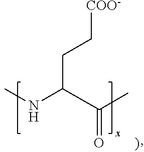

a poly(aspartic acid)

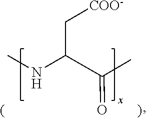

a poly(4-styrenesulfonic acid) (

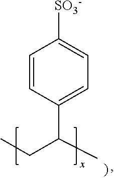

a poly(acrylic acid)

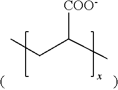

or a poly(methacrylic acid)

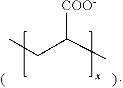

### Final Coating

The final coating is made of a porphyrin derivative which is either an anionic porphyrin of formula (IIa) or (IIb), preferably (IIa), or a cationic porphyrin of formula (IIc) or (IId), in particular (IIc).

In formula (IIa), (IIb), (IIc) and (IId), M is absent or is a metal selected from Zn, Mn, Fe, Cu, Co and Ni, preferably M is absent.

In formula (IIa), X₂ is a covalent bond or a spacer unit. The spacer unit may have the formula -A₂-L₂- wherein:
A₂ is linked to the porphyrin moiety and is selected from O, NR₁₅, CO, COO, CONR₁₅, OCO and NR₁₅CO; in particular from O, NR₁₅, COO, and CONR₁₅; especially from O, NR₁₅, and CONR₁₅; with R₁₅ being H or a (C₁-C₆)alkyl, and
L₂ is linked to the anionic group and is a covalent bond or a (C₁-C₆)alkanediyl (e.g. (CH₂)ₚ₂ with p2=1, 2, 3, 4, 5 or 6), L₂ being not a covalent bond when it is linked to a heteroatom (e.g. N or O) of the anionic group.

Thus, X₂ may be a covalent bond, O, NR₁₅, CONR₁₅, —O—(CH₂)ₚ₂—, —NR₁₅—(CH₂)ₚ₂, or —CONR₁₅—(CH₂)ₚ₂—; in particular a covalent bond, —O—(CH₂)ₚ₂—, —NR₁₅—(CH₂)ₚ₂—, or —CONR₁₅—(CH₂)ₚ₂—; especially a covalent bond, or —O—(CH₂)ₚ₂—, with p2 and R₁₅ as defined above, wherein the first atom of these groups is linked to the porphyrin moiety and the last atom is linked to the anionic group, wherein X₂ is not O, NR₁₅, or CONR₁₅ when it is linked to a heteroatom (e.g. N or O) of the anionic group.

In formula (IIa), R₂, R₃, R₄, and R₅, identical or different, preferably identical, are selected in particular from X₂COO⁻, X₂SO₃⁻, and X₂OSO₃⁻; more particularly from X₂COO⁻, and X₂SO₃⁻, wherein X₂ is as defined above.

In formula (IIc) or (IId), X₃ is a covalent bond or a spacer unit. The spacer unit may have the formula -A₃-L₃- wherein:
A₃ is linked to the porphyrin moiety and is selected from O, NR₁₆, CO, COO, CONR₁₆, OCO and NR₁₆CO; in particular from O, NR₁₆, COO, and CONR₁₆; especially from O, NR₁₆, and CONR₁₆; with R₁₆ being H or a (C₁-C₆)alkyl, and
L₃ is linked to the cationic group and is a covalent bond or a (C₁-C₆)alkanediyl (e.g. (CH₂)ₚ₃ with p3=1, 2, 3, 4, 5 or 6), L₃ being not a covalent bond when it is linked to a heteroatom (e.g. N or O) of the cationic group.

Thus, X₃ may be a covalent bond, O, NR₁₆, CONR₁₆, —O—(CH₂)ₚ₃—, —NR₁₆—(CH₂)ₚ₃—, or —CONR₁₆—(CH₂)ₚ₃—; in particular a covalent bond, —O—(CH₂)ₚ₃—, —NR₁₆—(CH₂)ₚ₃—, or —CONR₁₆—(CH₂)ₚ₃—; preferably a covalent bond, with p3 and R₁₆ as defined above, wherein the first atom of these groups is linked to the porphyrin moiety and the last atom is linked to the cationic group, wherein X₃ is not O, NR₁₆, or CONR₁₆ when it is linked to a heteroatom (e.g. N or O) of the cationic group.

In formula (IIc), R₆, R₇, R₈, and R₉, identical or different, preferably identical, are selected in particular from X₃N⁺Alk₄Alk₅Alk₆,

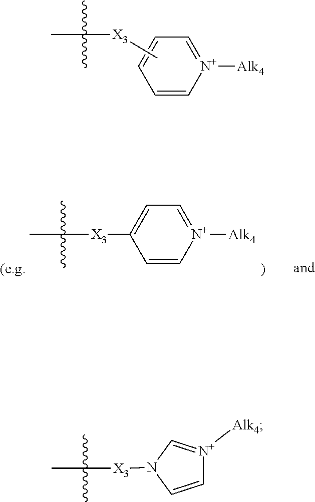

more particularly are X₃N⁺Alk₄Alk₅Alk₆; preferably are N⁺Alk₄Alk₅Alk₆, wherein X₃, Alk₄, Alk₅ and Alk₆ are as defined above.

In formula (IId), R₁₀, R₁₁, R₁₂, and R₁₃, identical or different, preferably identical, are selected in particular from X₃N⁺Alk₄Alk₅Alk₆,

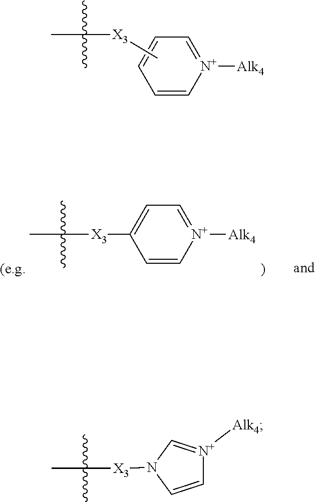

more particularly are

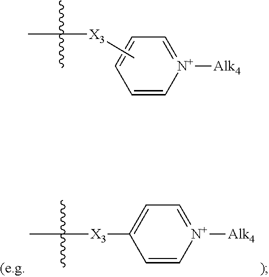

preferably are

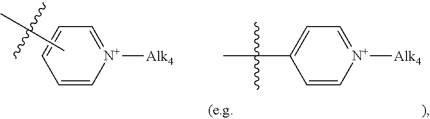

wherein X₃, Alk₄, Alk₅ and Alk₆ are as defined above.

According to a particular embodiment, the porphyrin derivative is an anionic porphyrin and is selected from:

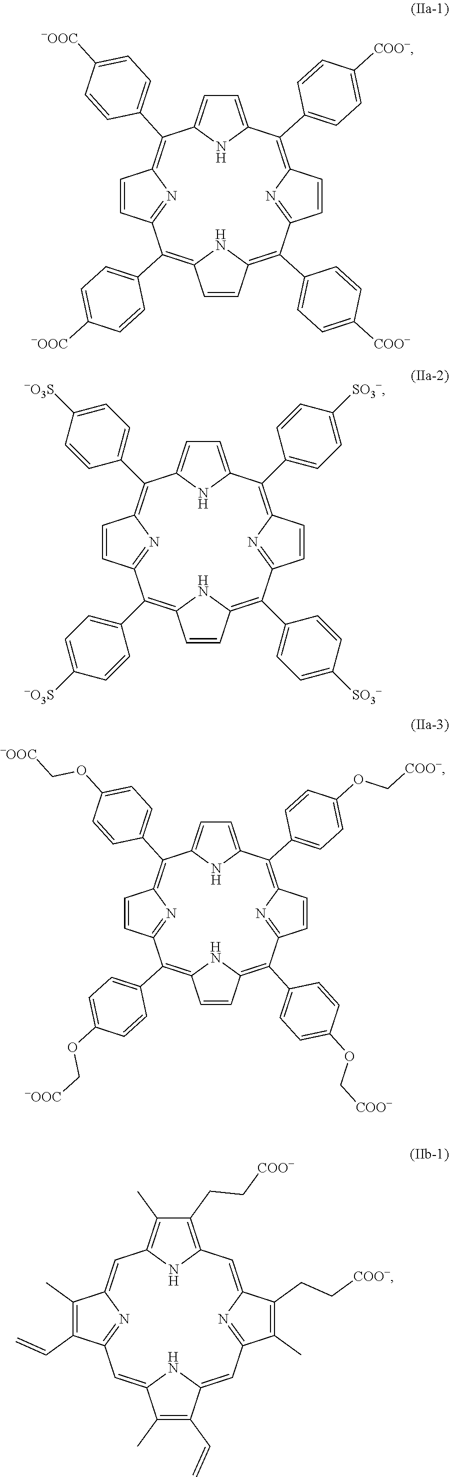

or is a cationic porphyrin and is selected from:

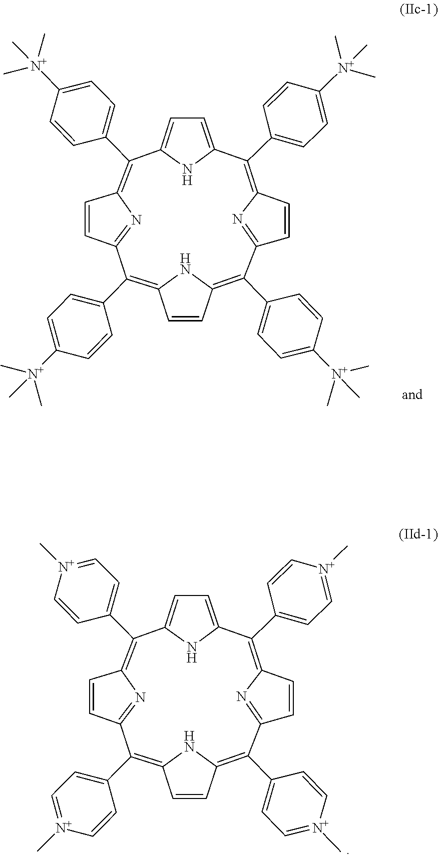

### Assembly

According a first particular embodiment, the assembly according to the invention is an assembly comprising a carbon nanotube, in particular a multi-walled carbon nanotube, coated successively with:
a primary coating resulting from the polymerisation of an amphiphilic diynic compound of formula (I-2);
an intermediate coating of a poly(diallyldimethylammonium); and
a final coating of a porphyrin derivative of formula (IIa-1).

According a second particular embodiment, the assembly according to the invention is an assembly comprising a carbon nanotube, in particular a multi-walled carbon nanotube, coated successively with:
a primary coating resulting from the polymerisation of an amphiphilic diynic compound of formula (I-2); and
a final coating of a porphyrin derivative of formula (IId-1).

### Method of Preparation

The present invention relates also to a method to prepare an assembly according to the invention comprising the following successive steps:
1) coating the carbon nanotube with a salt of an amphiphilic diynic compound of formula (I), and then polymerising the amphiphilic diynic compound of formula (I) in order to obtain a carbon nanotube coated with the primary coating;
2) optionally coating the carbon nanotube coated with the primary coating obtained in step 1) with a salt of a cationic or anionic polymer in order to obtain a carbon nanotube coated with the primary coating and the intermediate coating; and
3) coating the carbon nanotube coated with the primary coating obtained in step 1) or the carbon nanotube coated with the primary coating and the intermediate coating obtained in step 2) with a salt of the porphyrin derivative in order to obtain an assembly according to the invention.

### Step 1)

In this step, the carbon nanotube as defined above is first coated with a salt of an amphiphilic diynic compound of formula (I).

By “salt of an amphiphilic diynic compound of formula (I)” is meant an amphiphilic diynic compound of formula (I) associated with a counter-ion. When the R₁ group is an anionic group, the counter-ion is a cationic counter-ion and may be Na⁺, K⁺, or NH₄⁺, preferably Na⁺. When the R₁ group is a cationic group, the counter-ion is an anionic counter-ion and may be Cl⁻, Br⁻ or I⁻, preferably Cl⁻.

This salt can be added as such to the reaction medium or be formed in situ by adjusting the pH of the reaction medium.

This step can be performed in water, in particular in the presence of a buffer (e.g. Tris buffer), and/or under sonication.

The carbon nanotube coated with the amphiphilic diynic compound of formula (I) may be recovered after a centrifugation step in order to separate the salt of amphiphilic diynic compound of formula (I) which is not coated on the carbon nanotube.

The carbon nanotube coated with the amphiphilic diynic compound of formula (I) is then submitted to a polymerisation step in order to polymerise the diyne functions of the amphiphilic diynic compound of formula (I) and form the primary coating. This polymerisation can be performed under UV irradiation, notably at about 254 nm.

This polymerisation step can be performed in water, in particular in the presence of a buffer (e.g. Tris buffer).

### Step 2)

In this step, when present, the coated carbon nanotube obtained in step 1) is coated with a salt of a cationic or anionic polymer.

By “salt of a cationic or anionic polymer” is meant a cationic or anionic polymer associated with a counter-ion. When the polymer is anionic, the counter-ion is a cationic counter-ion and may be Na⁺, K⁺, or NH₄⁺, preferably Na⁺. When the polymer is cationic, the counter-ion is an anionic counter-ion and may be Cl⁻, Br⁻ or I⁻, preferably Cl⁻.

This salt can be added as such to the reaction medium or be formed in situ by adjusting the pH of the reaction medium.

This step can be performed in water, in particular in the presence of a buffer (e.g. Tris buffer).

The carbon nanotube coated with the primary coating and the intermediate coating may be recovered after a centrifugation step in order to separate the salt of the cationic or anionic polymer which is not coated on the carbon nanotube.

### Step 3)

In this step, the coated carbon nanotube obtained in step 2) when present or in step 1) if step 2) is not present is coated with a salt of the porphyrin derivative in order to obtain an assembly according to the invention.

By “salt of a porphyrin derivative” is meant a porphyrin derivative (i.e. an anionic porphyrin of formula (IIa) or (IIb) or a cationic porphyrin of formula (IIc) or (IId)) associated with a counter-ion. When the porphyrin derivative is anionic, the counter-ion is a cationic counter-ion and may be Na⁺, K⁺, or NH₄⁺, preferably Na⁺. When the porphyrin derivative is cationic, the counter-ion is an anionic counter-ion and may be Cl⁻, Br⁻ or I⁻, preferably Cl⁻.

This salt can be added as such to the reaction medium or be formed in situ by adjusting the pH of the reaction medium.

This step can be performed in water, in particular in the presence of a buffer (e.g. Tris buffer).

The assembly according to the invention thus obtained may be recovered after a centrifugation step in order to separate the salt of the porphyrin derivative which is not coated on the carbon nanotube.

### Applications

The present invention also relates to the use of an assembly according to the invention as a photocatalyst, especially in water.

Thus, the assembly according to the invention can be used as a catalyst under light irradiation, such as white or blue light irradiation (e.g. emitted by the sun or LEDs).

More particularly, the assembly according to the invention is useful to photocatalyse an oxidation reaction, especially in water, and in particular:
an oxidation reaction of a sulfide (to obtain the corresponding sulfone or sulfoxide) (the atom S is oxidized into SO or SO₂),
an oxidation reaction of an amine (to obtain the corresponding imine) (the moiety CH₂—NH is oxidized into a function CH═N),
an oxidation of an olefin (to obtain an enone) (the moiety CH₃—C═CH is oxidized into a moiety CH₂═C—C═O),
an oxidation of a dihydronaphthalen-1-ol, such as 1,4-dihydronaphthalen-1-ol (to give the corresponding naphtoquinone such as 1,4-naphthoquinone) (the moiety

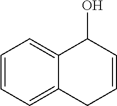 [SMILES: OC1C=CCc2ccccc21]

is oxidized into a moiety

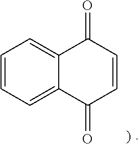 [SMILES: O=C1C=CC(=O)c2ccccc21]

The present invention also relates to the use of an assembly according to the invention for the production of singlet oxygen, in particular in the presence of dioxygen (more particularly in the presence of air, dioxygen being present in air) and under light irradiation (e.g. white or blue light irradiation, for example emitted by the sun or LEDs).

Thus, the present invention also concerns a method for producing singlet oxygen by contacting an assembly according to the invention with dioxygen, such as air, under light irradiation, such as white or blue light irradiation (e.g. emitted by the sun or LEDs).

The present invention also relates to the use of an assembly according to the invention for disinfection, in particular in the presence of dioxygen (more particularly in the presence of air, dioxygen being present in air) and under light irradiation (e.g. white or blue light irradiation, for example emitted by the sun or LEDs).

Indeed, as indicated above, the assembly according to the invention is able to produce singlet oxygen which is very reactive oxygen species capable of killing bacteria or viruses.

The present invention also relates to an assembly according to the invention for use as a photosensitizer agent in photodynamic therapy.

The present invention therefore also relates to the use of an assembly according to the invention for the manufacture of a drug intended to be used as a photosensitizer agent in photodynamic therapy.

The present invention also relates to the use of an assembly according to the invention as a photosensitizer agent in photodynamic therapy.

The present invention also concerns a method of treatment by photodynamic therapy comprising administering to a person in need thereof an effective amount of an assembly according to the invention as a photosensitizer agent.

Photodynamic therapy (PDT) is a medical treatment involving the combined use of a photosensitizer agent, dioxygen and light, the photosensitizer agent being a molecule capable of producing singlet oxygen in the presence of dioxygen and light. It can be used for example in the treatment of cancers (e.g. skin, head and neck, lung, bladder, oesophageal or brain cancer), as well as bacterial, fungal or viral infections (e.g. acne, herpes . . . ). In the present case, light may be white or blue light, notably emitted by LEDs.

The assembly according to the invention is also able to degrade some pollutants.

### FIGURES

FIG. 1 represents the structure of assembly 1 according to example 1.1.

FIG. 2 represents the structure of assembly 2 according to example 1.2.

FIG. 3 represents the calibration curve for determining the concentration of porphyrin TMPyP (used in example 1.2) based on an absorbance measurement (continuous line: determined based on measured absorbance for various concentrations; dotted line: calibration curve (y=127.82x) obtained by linear regression with an excellent determination coefficient R²=0.9979 proving the high quality of the correlation between the measured absorbance and the concentration of porphyrin TMPyP).

FIG. 4 represents the spectrum obtained by thermogravimetric analysis (TGA analysis) for DANTA polymer-coated CNTs.

FIG. 5 represents the spectrum obtained by TGA analysis for assembly 2.

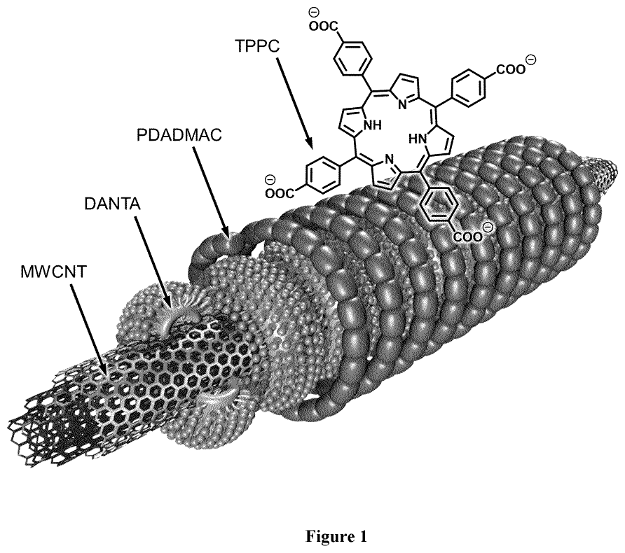

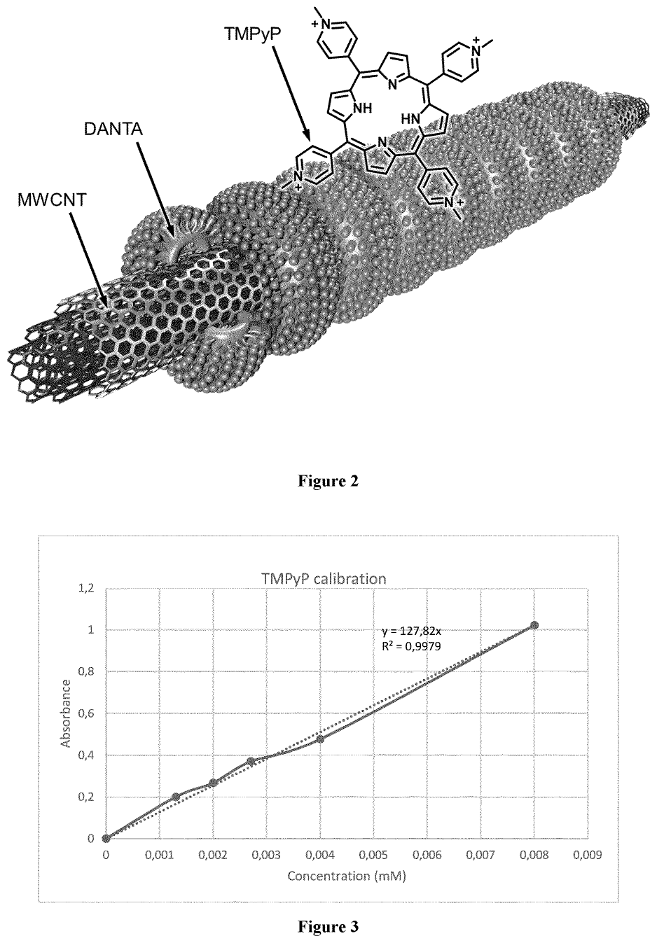

### EXAMPLES

### Example 1: Preparation of an Assembly

### 1.1. Assembly 1

### Primary Coating: Self-Assembly and Polymerization of a DANTA Amphiphile on Multi-Walled Carbon Nanotubes (CNTs)

Amphiphilic diacetylenic nitrilotriacetic lipid corresponding to the neutral form of compound of formula (I-2) (DANTA, 20 mg) was dissolved in aqueous Tris buffer (2 mL, pH 8) before CNTs (50 mg) were added. After 10 min of sonication with an ultra-sonic probe (5 min, 300 ms pulses per second, 25 W output power), a stable suspension was recovered and centrifuged at 5000×g for 3 min to remove amorphous carbon. The supernatant was collected and centrifuged at 11000×g for 45 min to separate the DANTA-coated carbon nanotubes from the excess of DANTA amphiphile. The pellet was resuspended in fresh Tris buffer and centrifuged again at 11000×g for 45 min. The final pellet was resuspended in buffer and submitted to UV irradiation (254 nm) for 8 h to polymerize the diacetylenic groups. This allows stabilizing the nanoring assemblies.

### Intermediate Coating: Self-Assembly of PDADMAC on the DANTA Polymer-Coated Carbon Nanotubes

The DANTA polymer-coated CNT suspension obtained in previous step was stirred in the presence of poly(diallyldimethylammonium chloride) (PDADMAC, 700 μL of a 20% solution in H₂O) for 1 h to induce the formation of the two-layer assembly. The excess of polymer was removed by centrifugation at 11000×g for 30 min and the pellet was resuspended in Tris buffer. This operation was repeated twice with Tris-buffer and two more times with pure water. The final pellet was resuspended in 1 mL of water.

Final coating: Self-assembly of porphyrin unit on the DANTA polymer-PDADMAC-coated carbon nanotubes

The porphyrin unit used in this example is TPPC having the following formula:

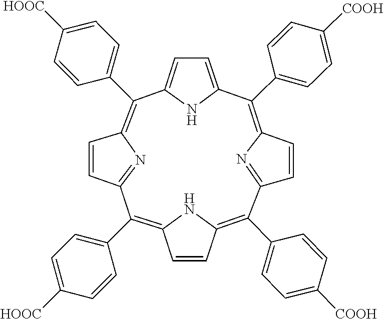 [SMILES: O=C(O)c1ccc(-c2c3nc(c(-c4ccc(C(=O)O)cc4)c4ccc([nH]4)c(-c4ccc(C(=O)O)cc4)c4nc(c(-c5ccc(C(=O)O)cc5)c5ccc2[nH]5)C=C4)C=C3)cc1]

0.5 mL of a 0.12 mM solution of TPPC in water is added to the DANTA polymer-PDADMAC-coated CNTs (0.5 mg of the suspension obtained in the previous step) in water at pH 9 (adjusted by adding a few drops of NaOH solution). The mixture is vortexed for 30 min. The suspension initially red in color becomes almost colorless when in contact with the DANTA polymer-PDADMAC-coated CNTs. The suspension is centrifuged at 3000×g for 5 min. The pellet is washed with water and centrifuged to afford the final assembly.

The combined supernatant aqueous phases are collected and analyzed by UV-visible spectrophotometry to measure the fraction of TPPC bound to the DANTA polymer-PDADMAC-coated CNT assemblies (difference of absorption before/after interaction with the assemblies). The amount of TPPC bound to 0.5 mg of DANTA polymer-PDADMAC-coated CNT was calculated to be ca. 0.04 μmol.

### 1.2. Assembly 2

### Primary Coating: Self-Assembly and Polymerization of a DANTA Amphiphile on Multi-Walled Carbon Nanotubes (CNTs)

The primary coating was prepared according to the same method as for preparing the primary coating of assembly 1.

### Final Coating: Self-Assembly of Porphyrin Unit on the DANTA Polymer-Coated Carbon Nanotubes

### Step 1:

TMPyP was synthesized by N-methylation of commercially available 5,10,15,20-tetrakis(4-pyridyl)porphyrin according to the following reaction:

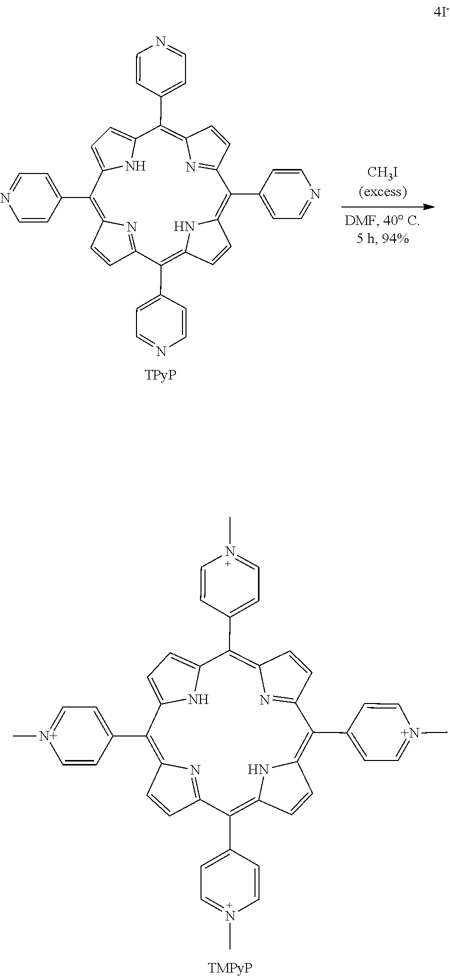

Excess of iodomethane (1.64 mL, 38.5 mmol) was added to a suspension of 5,10,15,20-tetrakis(4-pyridyl) porphyrin (TPyP) (60 mg, 0.097 mmol) in dry DMF (dimethylformamide, 10 mL). The reaction mixture was maintained under stirring for 5 h at 40° C. in a closed flask. After this period, the mixture was cooled, and the product precipitated with diethyl ether. The precipitate was filtered and washed with diethyl ether.

The solid was then taken in acetone/water (1:1) and, after concentration, it was again re-precipitated. The methylated product (TMPyP) was filtered, washed with acetone, and dried under vacuum, to yield a brown-reddish powder (180 mg, 94%).

Characterization of TMPyP: ¹H NMR (400 MHz, DMSO) δ 9.50 (d, J=8 Hz, 8H), 9.20 (s, 8H), 9.00 (d, J=8 Hz, 8H), 4.73 (s, 12H). ESI-MS; m/z [M⁴⁺]170, [M³⁺] 226. The data are in the line with those of the literature (Gomes et al. 2011).

### Step 2:

TMPyP (1.42 mg) was dissolved in H₂O (10 mL, 0.12 mM). The obtained solution (0.5 mL) was added to a suspension of the DANTA-coated CNTs (0.5 mg in 0.5 mL water) and the mixture was stirred on vortex for 1 h and then centrifuged at 5000×g for 5 min. The supernatant was discarded and the pellet was resuspended in water. This washing operation (suspension/centrifugation) was repeated four times with water to lead the final assembly.

### Characterization of Assembly 2:

The concentration of porphyrin deposited on DANTA polymer-coated CNT surface was determined using UV-Vis spectroscopy analysis.

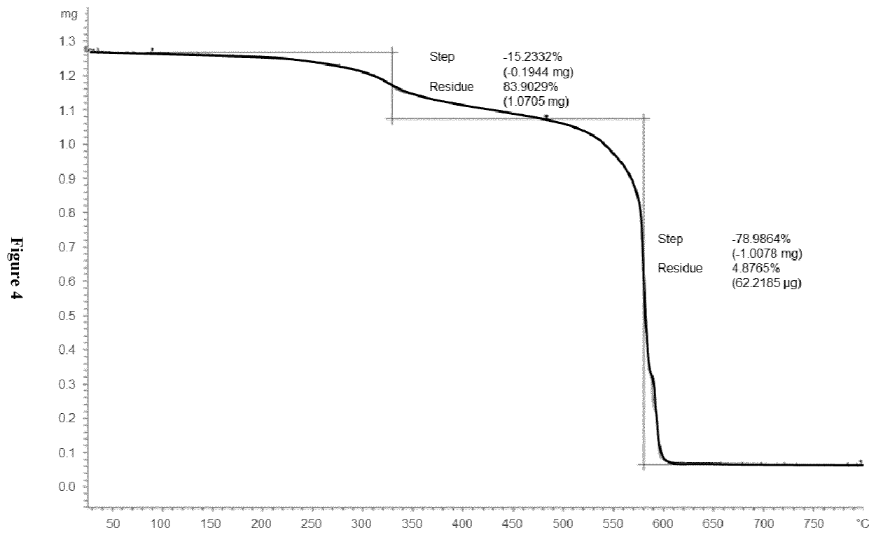

The porphyrin has a maximum absorption around 420 nm (Soret band). The concentration of porphyrin deposited on DANTA polymer-coated CNTs is determined using a calibration curve (see FIG. 3) determined by linear regression based on the following absorbance measures at 420 nm. The calibration curve was obtained by Abs measurements of incremental dilutions of a stock solution (40 μM TMPyP in water).

| Absorbance | Concentration (mM) | Dilution | V_{stock}/V_{dil} (μL/μL) |
|---|---|---|---|
| 1.02305 | 0.008 | D5 | 300/1200 |
| 0.476444 | 0.004 | D10 | 150/1350 |
| 0.369953 | 0.0027 | D15 | 101/1399 |
| 1450.267841 | 0.002 | D20 | 75/1425 |
| 0.200041 | 0.0013 | D30 | 50/1450 |

Porphyrin concentration was obtained by the difference between the initial concentration of the porphyrin solution (0.04 mM) and the residual concentration in the supernatant after assembly, added to the concentration in the 4 wash waters. A molar concentration of 0.03 μmol was obtained for 0.5 mg of CNT.

| Absorbance | Concentration | Fraction |
|---|---|---|
| 0.186648 | 0.001460241 | H2O washing (1) |
| 0.097121 | 0.000759826 | H₂O washing (2) |
| 0.0589788 | 0.000469488 | H₂O washing (3) |
| 0.0255313 | 0.000199744 | H₂O washing (4) |
| 0.189549 | 0.0014829 | Supernatant (150 μL) |
| | | diluted with water (1350 μL) |

The composition in mass percent of assembly 2 was also determined by thermogravimetric analysis (TGA).

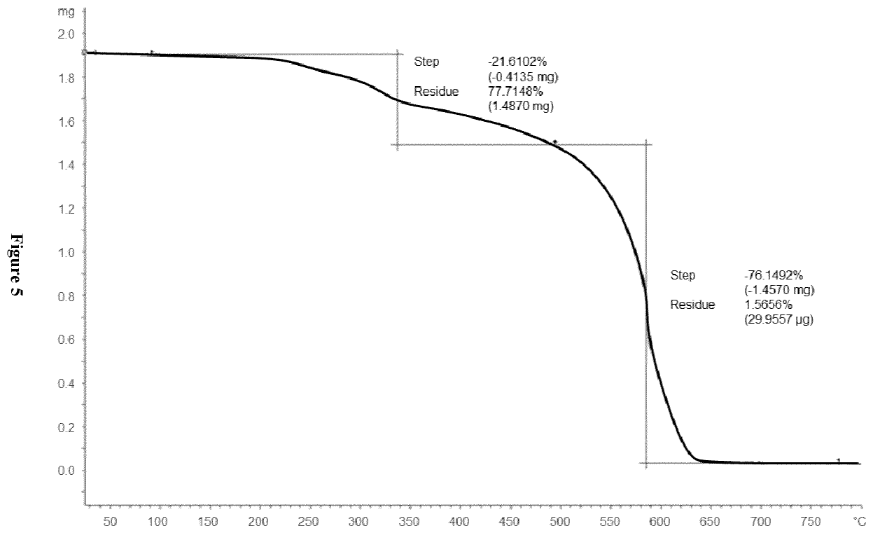

FIGS. 4 and 5 were obtained by TGA analysis for the DANTA polymer-coated CNTs and the final assembly 2 respectively. The degradation of the porphyrin was observed at ca. 250° C., that of DANTA amphiphile at ca. 320° C., and that of CNT above 480° C. These experiments showed that assembly 2 contains 6 wt % of porphyrin.

### Example 2: Evaluation of Assembly 1 as Photocatalyst in Sulfide Oxidations in Water

The hybrid photocatalyst (assembly 1 of example 1.1) was tested in a photo-oxidation reaction of sulfides into the corresponding sulfoxides, under aerobic conditions and light activation.

The photocatalyst is simply suspended in water (100 μp of the suspension obtained at the end of example 1.1 corresponding to ca. 0.04 μmol of TPPC) in a round-bottom flask, and the sulfide (0.2 mmol) is added. Under stirring, the reaction mixture is then exposed to a light source (blue light LED in this example but it may be white light) for ca. 1 h.

The following sulfides have been tested in the above-mentioned photocatalyzed photo-oxidation reaction in water:

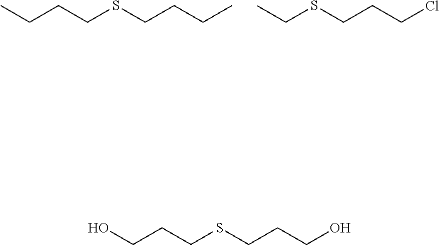

10-15% of conversion of these sulfides have been obtained in the above-mentioned oxidation reaction conditions.

The photocatalyst has been recovered at the end of the reaction by a mild centrifugation process (3000×g), washed with water and reused in the next run.

### Example 3: Evaluation of Assembly 2 as Photocatalyst in Sulfide Oxidations in Water

In a round bottom flask (10 mL), the sulfide reactant (0.04 mmol) was dissolved in buffer (25 mM Tris in D₂O, 180 μL) and assembly 2 obtained in example 1.2 was added (20 μL, 0.1 mol %) to the reaction mixture. The septum-closed flask was exposed to white LED light (7.8 W, 620 LUMENS/M, 4000 K) under stirring. The reaction was performed at room temperature until total conversion (determined by ¹H NMR of crude product).

The results obtained are presented in the table below.

| | Water | Time | Conv. | Select | |
|---|---|---|---|---|---|
| Sulfides | solubility | (h) | (%) | (%)* | Major product |
| 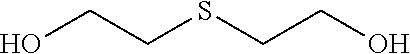 | Miscible | 3.5 | 100 | 93:7 | 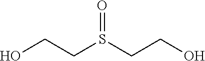 |
| 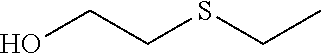 | Soluble (70 g/L) | 3 | 100 | 91:9 | 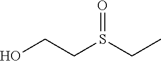 |
| 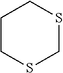 | Slightly soluble (1.1 g/L) | 3 | 86 | 95:5 | 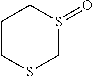 |
| 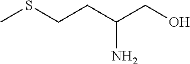 | Slightly soluble | 2.5 | 100 | 92:8 | 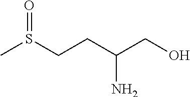 |

*selectivity with regards to the corresponding sulfone obtained as by-product

### BIBLIOGRAPHIC REFERENCES

Buglak et al. Journal of Photochemistry and Photobiology A: Chemistry 2020, 403, 112833;
Costa e Silva et al. Beilstein J. Org. Chem. 2020, 16, 917;
Ehli et al. J. Am. Chem. Soc. 2006, 128, 11222-11231;
Gomes et al. Photochem. Photobiol. Sci., 2011, 10, 1735;
Lu et al. Journal of Molecular Catalysis A: Chemical 2016, 417, 122-125;
Spencer et al. ACS Omega 2022, 7(45), 41304;
Wang et al. ACS Appl. Nano Mater. 2021, 4(3), 2345-2350;
Zhang et al. Carbon 2017, 124, 618-629.

1-15. (canceled)

16. An assembly comprising a carbon nanotube coated successively with:
a primary coating resulting from the polymerisation of an amphiphilic diynic compound of following formula (I): 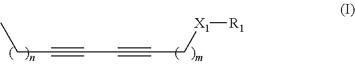
wherein:
n is an integer from 6 to 20,
m is an integer from 4 to 20,
X₁ is a covalent bond or a spacer unit, and
R₁ is an anionic group selected from COO⁻, SO₃⁻, OSO₃⁻, N((CH₂)_{q1}COO⁻)((CH₂)_{q2}COO⁻), N((CH₂)_{q1}SO₃⁻)((CH₂)_{q2}SO₃⁻), N((CH₂)_{q1}OSO₃⁻)((CH₂)_{q2}OSO₃⁻), CH((CH₂)_{q3-1}COO⁻)N((CH₂)_{q1}COO⁻)((CH₂)_{q2}COO⁻), CH((CH₂)_{q3-1}SO₃⁻)N((CH₂)_{q1}SO₃⁻)((CH₂)_{q2}SO₃⁻) and CH((CH₂)_{q3-1}OSO₃⁻)N((CH₂)_{q1}OSO₃⁻)((CH₂)_{q2}OSO₃⁻) with q1, q2 and q3, identical or different, each representing 1, 2, 3, 4, 5 or 6; or a cationic group selected from N⁺Alk₁Alk₂Alk₃, 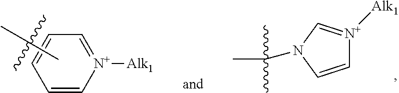
wherein Alk₁, Alk₂ and Alk₃ are independently a (C₁-C₆)alkyl;
and
a final coating of a porphyrin derivative which is either an anionic porphyrin or a cationic porphyrin,
wherein the anionic porphyrin is an anionic tetraphenylporphyrin of following formula (IIa) or an anionic protoporphyrin of following formula (IIb): 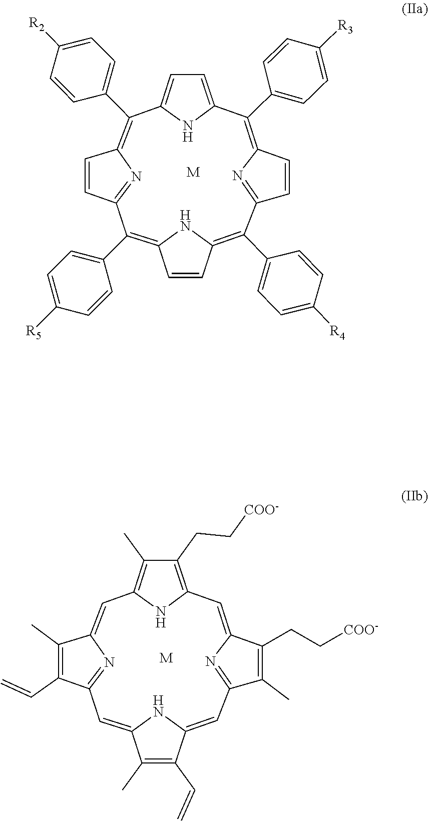
wherein:
M is absent or is a metal selected from Zn, Mn, Fe, Cu, Co and Ni, and
R₂, R₃, R₄, and R₅, identical or different, are selected from H, X₂COO⁻, X₂SO₃⁻, and X₂OSO₃⁻, wherein X₂ is a covalent bond or a spacer unit, and wherein at least one of R₂, R₃, R₄, and R₅ is not H,
wherein the cationic porphyrin is a cationic tetraphenylporphyrin of following formula (IIc) or a cationic porphyrin of following formula (IId): 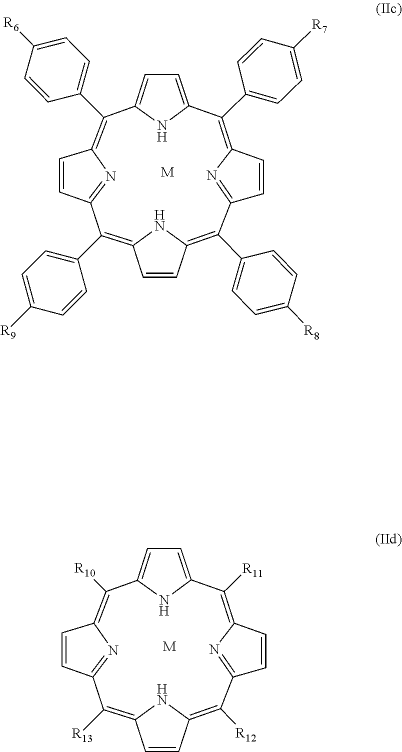
wherein:
M is as defined above,
R₆, R₇, R₈, and R₉, identical or different, are selected from H, X₃N⁺Alk₄Alk₅Alk₆, 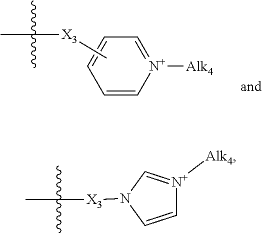
wherein X₃ is a covalent bond or a spacer unit, wherein Alk₄, Alk₅ and Alk₆ are independently a (C₁-C₆)alkyl, and wherein at least one of R₆, R₇, R₈, and R₉ is not H, and
R₁₀, R₁₁, R₁₂, and R₁₃, identical or different, are selected from H, X₃N⁺Alk₄Alk₅Alk₆, 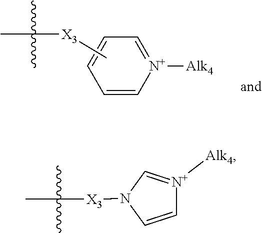
wherein X₃, Alk₄, Alk₅ and Alk₆ are as defined above, and wherein at least one of R₁₀, R₁₁, R₁₂, and R₁₃ is not H,
wherein the porphyrin derivative is:
a cationic porphyrin when R₁ is an anionic group and there is no intermediate coating or when R₁ is a cationic group and there is an intermediate coating of an anionic polymer, and
an anionic porphyrin when R₁ is a cationic group and there is no intermediate coating or when R₁ is an anionic group and there is an intermediate coating of a cationic polymer.

17. The assembly according to claim 16, wherein X₁ is a covalent bond or a spacer unit which has the formula -A₁-L₁- wherein:
A₁ is linked to the moiety comprising the diyne group and is selected from O, NR₁₄, CO, COO, CONR₁₄, OCO and NR₁₄CO; with R₁₄ being H or a (C₁-C₆)alkyl, and
L₁ is linked to R₁ and is a covalent bond or a (C₁-C₆)alkanediyl, L₁ being not a covalent bond when it is linked to a heteroatom, such as N or O, of R₁.

18. The assembly according to claim 16, wherein R₁ is an anionic group selected from COO⁻, OSO₃⁻, N((CH₂)_{q1}COO⁻)((CH₂)_{q2}COO⁻), and CH((CH₂)_{q3-1}COO⁻)N((CH₂)_{q1}COO⁻)((CH₂)_{q2}COO⁻); or a cationic group selected from N⁺Alk₁Alk₂Alk₃, 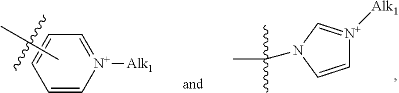
in which Alk₁, Alk₂ and Alk₃ are independently a (C₁-C₆)alkyl.

19. The assembly according to claim 16, wherein the amphiphilic diynic compound of formula (I) is anionic and is selected from: 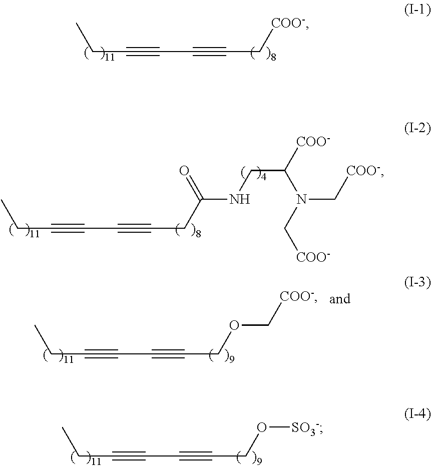
or is cationic and is selected from:

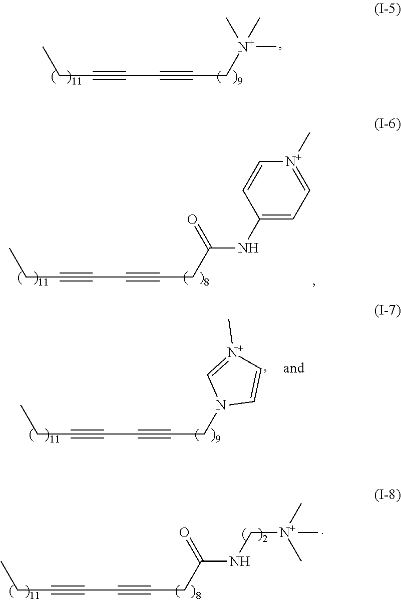

20. The assembly according to claim 16, wherein the cationic polymer is a poly(diallyldi(C₁-C₆)alkylammonium), a poly(lysine) in which the NH₂ group of the side chain has been replaced by a tri(C₁-C₆)alkylammonium, or a poly(allylamine) in which the NH₂ group of the side chain has been replaced by a tri(C₁-C₆)alkylammonium, and the anionic polymer is an anionic form of a poly(glutamic acid), a poly(aspartic acid), a poly(4-styrenesulfonic acid), a poly(acrylic acid) or a poly(methacrylic acid).

21. The assembly according to claim 16, wherein M is absent.

22. The assembly according to claim 16, wherein:
X₂ is a covalent bond or a spacer unit which has the formula -A₂-L₂- wherein:
A₂ is linked to the porphyrin moiety and is selected from O, NR₁₅, CO, COO, CONR₁₅, OCO and NR₁₅CO; with R₁₅ being H or a (C₁-C₆)alkyl, and
L₂ is linked to the anionic group and is a covalent bond or a (C₁-C₆)alkanediyl, L₂ being not a covalent bond when it is linked to a heteroatom of the anionic group;
R₂, R₃, R₄, and R₅, identical or different, are selected from X₂COO⁻, X₂SO₃⁻, and X₂OSO₃⁻;
X₃ is a covalent bond or a spacer unit which has the formula -A₃-L₃- wherein:
A₃ is linked to the porphyrin moiety and is selected from O, NR₁₆, CO, COO, CONR₁₆, OCO and NR₁₆CO; with R₁₆ being H or a (C₁-C₆)alkyl, and
L₃ is linked to the cationic group and is a covalent bond or a (C₁-C₆)alkanediyl, L₃ being not a covalent bond when it is linked to a heteroatom of the cationic group;
R₆, R₇, R₈, and R₉, identical or different, are selected from X₃N⁺Alk₄Alk₅Alk₆, 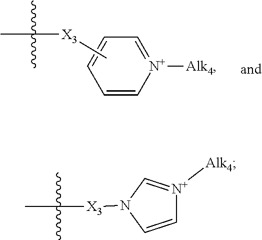
and
R₁₀, R₁₁, R₁₂, and R₁₃, identical or different, are selected from X₃N⁺Alk₄Alk₅Alk₆,

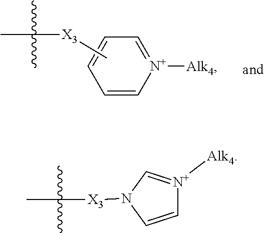

23. The assembly according to claim 16, wherein the porphyrin derivative is an anionic porphyrin selected from: 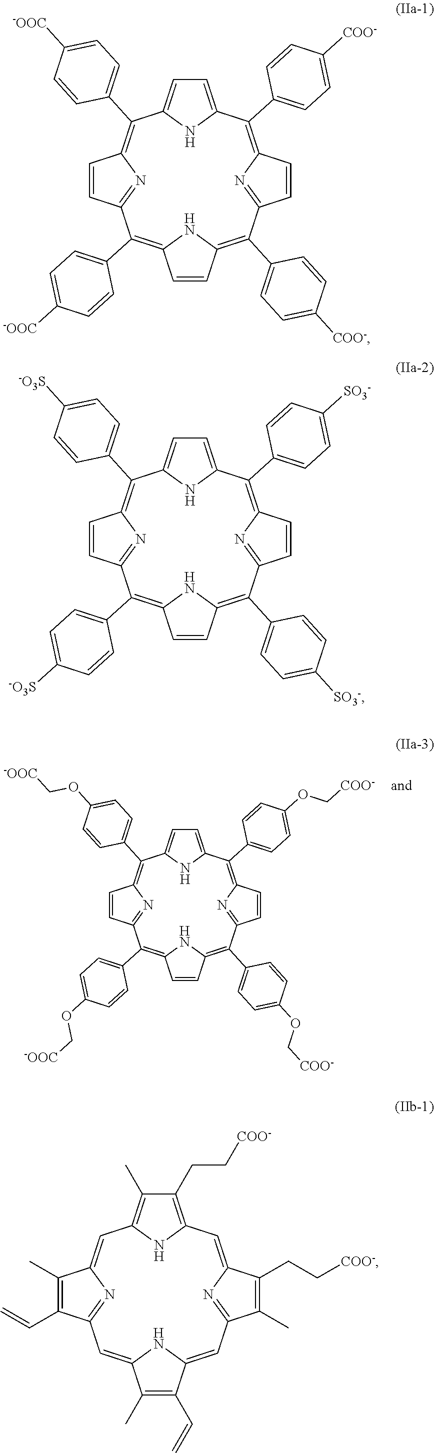
or is a cationic porphyrin selected from:

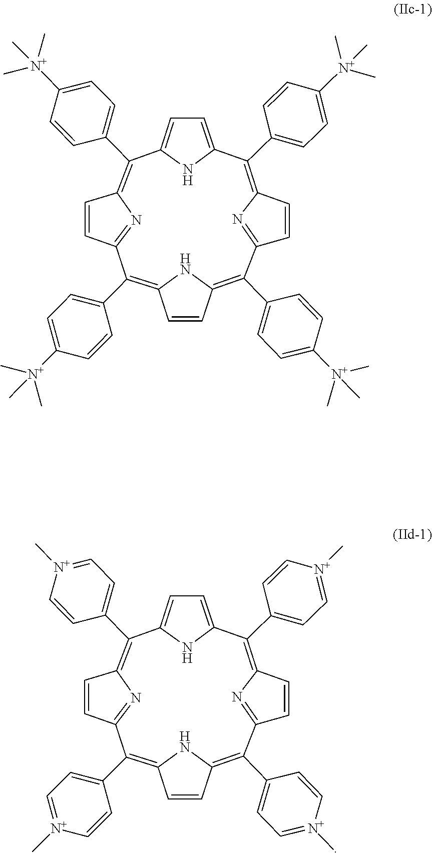

24. The assembly according to claim 16, wherein:
the amphiphilic diynic compound has the following formula (I-2): 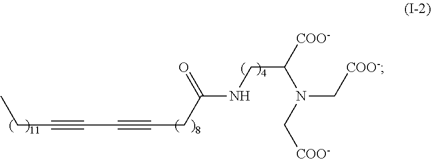
the intermediate coating is present and is made of a poly(diallyldimethylammonium); and
the porphyrin derivative has the following formula (IIa-1):

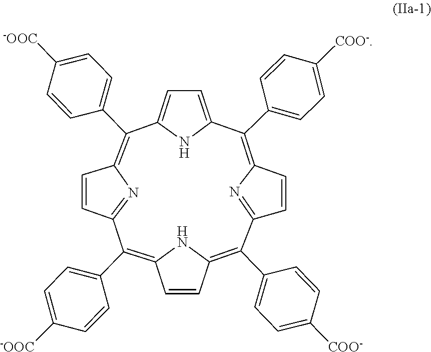

25. A method to prepare an assembly according to claim 16 comprising the following successive steps:
1) coating the carbon nanotube with a salt of an amphiphilic diynic compound of formula (I), and then polymerising the amphiphilic diynic compound of formula (I) in order to obtain a carbon nanotube coated with the primary coating; and
2) coating the carbon nanotube coated with the primary coating obtained in step 1) with a salt of the porphyrin derivative in order to obtain an assembly according to the invention.

26. A method for the photocatalysis of an oxidation reaction wherein the assembly of claim 16 acts as catalyst, or for the production of singlet oxygen, or for disinfection by contacting an assembly according to claim 16 with dioxygen.

27. A method of treatment by photodynamic therapy comprising administering to a person in need thereof an effective amount of an assembly according to claim 16 as a photosensitizer agent.

28. The assembly according to claim 16, coated successively with:
a primary coating as defined in claim 16,
an intermediate coating of a cationic polymer if R₁ is an anionic group or an anionic polymer if R₁ is a cationic group, and
a final coating as defined in claim 16.

29. A method to prepare an assembly according to claim 28 comprising the following successive steps:
1) coating the carbon nanotube with a salt of an amphiphilic diynic compound of formula (I), and then polymerising the amphiphilic diynic compound of formula (I) in order to obtain a carbon nanotube coated with the primary coating;
2) coating the carbon nanotube coated with the primary coating obtained in step 1) with a salt of a cationic or anionic polymer in order to obtain a carbon nanotube coated with the primary coating and the intermediate coating; and
3) coating the carbon nanotube coated with the primary coating and the intermediate coating obtained in step 2) with a salt of the porphyrin derivative in order to obtain an assembly according to the invention.
